(19) United States
(12) Patent Application Publication
(10) Pub. No.: US 2007/0190198 A1
(43) Pub. Date: Aug. 16, 2007

(54) APPARATUS FOR PROCESSING POLYPROPYLENE COMPOUND CONTAINING GLASS BUBBLE

(75) Inventors: Suk Sun Ka, Yongin-si (KR); Duk Chul Jeon, Yongin-si (KR); Han Seok Song, Daejeon (KR)

Correspondence Address: GREENBLUM & BERNSTEIN, P.L.C., 1950 ROLAND CLARKE PLACE, RESTON, VA, 20191, US

(73) Assignees: HYUNDAI MOBIS CO., LTD., Seoul (KR); GS Caltex Corporation, Seoul (KR)

(21) Appl. No.: 11/468,886

(22) Filed: Aug. 31, 2006

(30) Foreign Application Priority Data
Feb. 16, 2006 (KR) 10-2006-0015165

(51) Int. Cl. B29C 47/36

(52) U.S. Cl. 425/205

(57) ABSTRACT

Disclosed herein is an apparatus for processing a polypropylene compound containing glass bubbles. The processing apparatus includes an extruder receiving a screw therein, a first hopper mounted on an outer peripheral surface of the extruder at a position corresponding to a beginning portion of the screw and used to introduce the polypropylene compound, which is a main material, into the extruder, and a second hopper mounted on the outer peripheral surface of the extruder at a position spaced apart from the first hopper by a predetermined distance and used to introduce glass bubbles into the extruder, so as to allow the glass bubbles to be mixed with the polypropylene compound that is being transferred by the screw. The processing apparatus has the effect of preventing damage to glass bubbles by minimizing a passage distance of the glass bubble along the screw of the extruder, thereby achieving a reduced weight and improved physical properties of a molded article to be discharged from the extruder.

### BACKGROUND OF THE INVENTION

1. Field of the Invention

The present invention relates to an apparatus for processing a polypropylene compound containing glass bubbles in which a first hopper for the introduction of the polypropylene compound is spaced apart from a second hopper for the introduction of the glass bubbles, thereby restricting damage to the glass bubbles and consequently, achieving a reduced weight and improved mechanical properties of a molded article.

2. Description of the Related Art

Generally, polypropylene compounds are used to form interior and exterior sheaths of a vehicle. During processing of the polypropylene compounds, talc and rubber are introduced into a hopper, alone with polypropylene as a main component, so as to be processed together by an extruder.

The extruder is a device for making a material to be formed into a flowable material by heating, compressing and advancing the molten material by means of a screw, and passing the compressed molten material through a specifically shaped die, so as to continuously form products having a specific cross section. The screw of the extruder has functions of supplying compressing, mixing, homogenizing and transferring materials in the form of pellets or beads.

FIG. 1 is a schematic view illustrating a conventional extruder for forming interior and exterior sheaths of a vehicle by use of a polypropylene compound.

As shown in FIG. 1, the conventional extruder 10 receives a screw 13 therein. The screw 13 has functions of compressing, mixing, homogenizing and transferring materials.

A hopper 11 is mounted on an outer peripheral surface of the extruder 10 at a position corresponding to a beginning portion of the screw 13. The hopper 11 has a function of supplying materials into the extruder 10.

A die 14 is mounted to the extruder 10 at a position corresponding to an ending portion of the screw 13. The die 14 has a function of forming, a content being discharged from the extruder 10 to have a specific shape.

A kneading block 16 is formed at a middle portion of the screw 13. The kneading block 16 is a screw element designed to generate a high shearing force for the purpose of melting and mixing of polymer resin, etc. to be processed, and consists of several sealing disks.

A heater 15 is located proximal to the outer peripheral surface of the extruder 10, and enables melting of materials.

Explaining the operating procedure of the extruder 10 having the above described configuration in brief, if a material is introduced into the extruder 10, which is kept at a predetermined temperature, through the hopper 11, the material is transferred by the screw 13 while coming into frictional contact with an inner peripheral surface of the extruder 10.

In the course of king transferred by the screw 13, the material is completely melted by frictional heat as well as heat transmitted from the heater 15. The resulting molten material is compressed by the screw 13.

The compressed material is continuously extruded through the specifically shaped die 14 such that the extruded molten material has a specific cross sectional shape. The resulting formed material, having passed through the die 14, is solidified by use of a cooling device (not shown), which is located at the outside of the extruder 10, to maintain the specific cross sectional shape thereof.

During the above described operation of the extruder 10, the melting and mixing of the material can be efficiently performed thanks to the kneading block 16 provided at the middle portion of the screw 11.

Meanwhile, the material used to form interior and exterior sheaths of a vehicle may be a compound of polypropylene, talc and rubber. In addition to the above mentioned constituent components, glass bubbles may be added at a predetermined rate in consideration of a high load of the talc.

However, when the respective constituent components of the compound are introduced simultaneously into the hopper, there is a problem in that the glass bubbles may be broken by collision therebetween as the compound is transferred via the screw.

In particular, the glass bubbles have a high possibility of damage when passing through the kneading block of the screw, and the resulting damaged glass bubble may cause deterioration in physical properties of the compound.

### SUMMARY OF THE INVENTION

Therefore, the present invention has been made in view of the above problems, and it is an object of the present invention to provide an apparatus for processing a polypropylene compound containing glass bubbles in which an independent glass bubble hopper is mounted to an extruder to allow glass bubbles to be introduced into the extruder via an independent exclusive supply path, thereby minimizing the transfer time of the glass bubbles along a screw and preventing breakage of the glass bubbles.

In accordance with the present invention, the above and other objects can be accomplished by the provision of an apparatus for processing a polypropylene compound containing glass bubbles; an extruder receiving a screw therein; a first hopper mounted on an outer peripheral surface of the extruder at a position corresponding to a beginning portion of the screw and used to introduce the polypropylene compound, which is a main material, into the extruder; and a second hopper mounted on the outer peripheral surface of the extruder at a position spaced apart from the first hopper by a predetermined distance and used to introduce glass bubbles into the extruder, so as to allow the glass bubbles to be mixed with the polypropylene compound that is being transferred by the screw.

The processing apparatus has the effect of preventing damage to glass bubbles by minimizing a time required for the glass bubbles to pass through the screw of the extruder, thereby achieving a reduced weight and improved physical properties of a molded article to be discharged from the extruder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a conventional extruder for forming interior and exterior sheaths of a vehicle by use of a polypropylene compound; and

FIG. 2 is a schematic view illustrating an extruder for forming interior and exterior sheaths of a vehicle by use of a polypropylene compound according to the present invention.

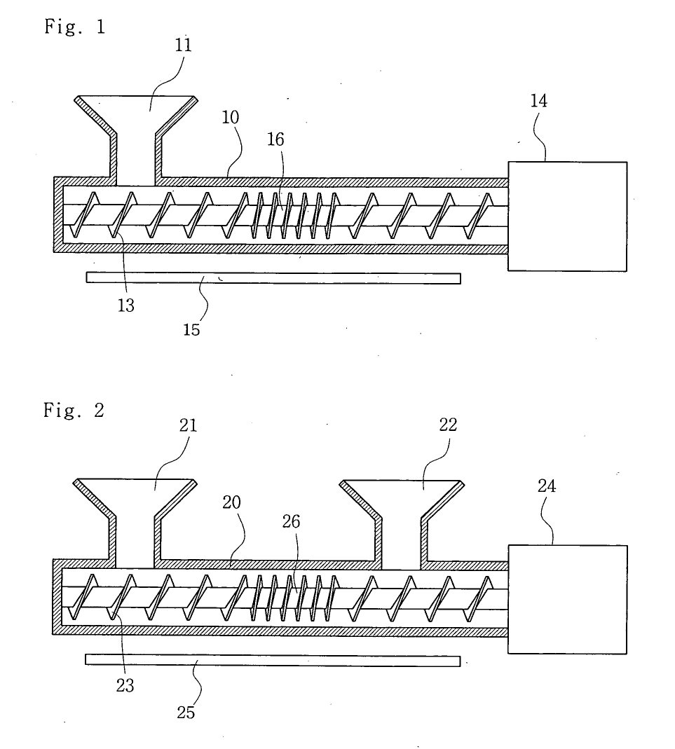

### DESCRIPTION OF THE PREFERRED EMBODIMENTS

Now, a preferred embodiment of the present invention will be explained with reference to the accompanying drawing.

FIG. 2 is a schematic view illustrating an extruder for forming interior and exterior sheaths of a vehicle by use of a polypropylene compound according to the present invention.

As shown in FIG. 2, the extruder 20 of the present invention receives a screw 23 therein. The screw 23 has functions of compressing, mixing, homogenizing and transferring materials.

A first hopper 21 is mounted on an outer peripheral surface of the extruder 20 at a position corresponding to a beginning portion of the screw 23. The first hopper 11 is used to introduce a polypropylene compound, which is a main material of interior and exterior sheaths of a vehicle, into the extruder 20.

A die 24 is mounted to a discharge portion of the extruder 20 at a position corresponding to an ending portion of the screw 23. The die 24 has a function of forming a content being discharged from the extruder 20 to have a specific shape.

In the present invention, a second hopper 22 is mounted on the outer peripheral surface of the extruder 20 at a position spaced apart from the first hopper 21 by a predetermined distance. The second hopper 22 is used to introduce glass bubbles into the extruder 20, so as to allow the glass bubbles to be mixed with the polypropylene compound as die compound is being transferred by the screw 23.

A heater 25 is located proximal to the outer peripheral surface of the extruder 20, and enables melting of materials.

Meanwhile, the screw 23 is provided with a kneading block 26 at a position between the first hopper 21 and the second hopper 22. The kneading block 26 is a screw element designed to generate a high shearing force for the purpose of melting and mixing of polymer resin, etc. to be processed, and consists of several sealing disks.

Now, the operation of die present invention having the above described configuration will be explained in detail.

If a polypropylene compound, which consists of polypropylene, talc rubber, etc., is introduced into the extruder 20, which is kept at a predetermined temperature, through the first hopper 21, the compound is transferred by the screw 23 while coming into frictional contact with an inner peripheral surface of the extruder 20.

In the course of being transferred by the screw 23, the compound is completely melted by frictional heat as well as heat transmitted from the heater 25. The resulting molten material is compressed by the screw 23.

The compressed compound is continuously extruded through the specifically shaped die 24 such that the extruded molten material has a specific cross sectional shape. The resulting formed material, having passed through the die 24, is solidified by use of a cooling device (not shown), which is located at the outside of the extruder 20, to maintain the specific cross sectional shape thereof.

In the present invention, file second hopper 22 is provided at a position spaced apart from the first hopper 21 by a predetermined distance. Accordingly, separately from the polypropylene compound, glass bubbles are able to be introduced through the second hopper 22, and advanced while being mixed with the compound that is being transferred by the screw 23.

Here, it is desirable that tee distance between the first and second hoppers 21 and 22 be adjusted to minimize a movement path of the glass bubbles within the extruder 20 in order to prevent damage to the glass bubbles due to high-temperature or high-pressure while guaranteeing the sufficient mixing of the glass bubbles and polypropylene compound within the extruder 20.

Thanks to positioning the kneading block 26 of the screw 11 after the first hopper 21 and before the second hopper 22, the glass bubbles, which tend to be easily damaged, have no need to pass the kneading block 26. This consequently has the effect of preventing damage to the glass bubbles.

As apparent from the above description, the present invention provides an apparatus for processing a polypropylene compound containing glass bubbles in which the polypropylene compound is introduced into a first hopper, and the glass bubbles are introduced into a second hopper. With this configuration, a movement path of the glass bubbles within an extruder can be minimized. This has the effect of allowing the glass bubbles to maintain their shapes stably and achieving a reduced weight and improved mechanical properties of a molded article.

In particular, as a result of positioning a kneading block of a screw after the first hopper and before the second hopper, it is possible to completely prevent damage to the glass bubbles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for processing, a polypropylene compound containing glass bubbles:
an extruder receiving a screw therein;
a first hopper mounted on an cuter peripheral surface of the extruder at a position corresponding to a beginning portion of the screw and used to introduce the polypropylene compound, which is a main material, into the extruder; and
a second hopper mounted on the outer peripheral surface of the extruder at a position spaced apart from the first hopper by a predetermined distance and used to introduce glass bubbles into the extruder, so as to allow the glass bubbles to be mixed with the polypropylene compound that is being transferred by the screw.

2. The apparatus according to claim 1, wherein the screw is provided with a kneading block at a position after the first hopper and before the second hopper.
